(19) United States
(12) Patent Application Publication
(10) Pub. No.: US 2012/0146812 A1
(43) Pub. Date: Jun. 14, 2012

(54) SYSTEM AND METHOD FOR DISSEMINATING CAR ACCIDENT

(75) Inventor: Jae Hong RUY, Daejeon (KR)

(73) Assignee: ELECTRONICS AND TELECOMMUNICATIONS RESEARCH INSTITUTE, Daejeon (KR)

(21) Appl. No.: 13/313,774

(22) Filed: Dec. 7, 2011

(30) Foreign Application Priority Data
Dec. 8, 2010 (KR) 10-2010-0124888

(51) Int. Cl. G08G 1/09

(52) U.S. Cl. 340/905

(57) ABSTRACT

Provided is a system and method for disseminating an accident. The accident dissemination system may include a sensor to sense the accident and to generate accident information; and a vehicle processor to open an S channel and thereby transmit the accident information to a vehicle at the rear entering an accident location where the accident has occurred, and to transmit the accident information to an oncoming vehicle, travelling in the opposite direction and being alienated from the accident location, via a first D channel opened by the oncoming vehicle.

### CROSS-REFERENCE TO RELATED APPLICATION

This application claims the benefit of Korean Patent Application No. 10-2010-0124888, filed on Dec. 8, 2010, in the Korean Intellectual Property Office, the disclosure of which is incorporated herein by reference.

### BACKGROUND

1. Field of the Invention

Embodiments of the present invention relate to an accident dissemination system and method that may transfer accident information to a control center server via a vehicle, thereby enabling an emergency disposal to be quickly performed, or may transmit accident information to a vehicle that is to enter an accident location where an accident has occurred, thereby preventing a traffic congestion.

2. Description of the Related Art

In a conventional art, when an accident occurs in a vehicle, a structure, and the like, a human being having witnessed the accident may provide accident information, for example, an accident location and an accident type, and thereby inform that the accident has occurred.

In this case, when the accident occurs in a place where people barely go around, a control sensor may not readily obtain accident information and thus, clearing of the accident may be delayed. Also, when vehicles enter a corresponding accident location without being aware of the accident having occurred, it may cause a traffic congestion.

### SUMMARY

An aspect of the present invention provides an accident dissemination system and method that may transfer accident information to a control center server via a vehicle, thereby enabling an emergency disposal to be quickly performed, or may transmit accident information to a vehicle that is to enter an accident location where an accident has occurred, thereby preventing a traffic congestion.

According to an aspect of the present invention, there is provided a system for disseminating an accident, the system including: a sensor to sense the accident and to generate accident information; and a vehicle processor to open an S channel and thereby transmit the accident information to a vehicle at the rear entering an accident location where the accident has occurred, and to transmit the accident information to an oncoming vehicle, travelling in the opposite direction and being alienated from the accident location, via a first D channel opened by the oncoming vehicle.

The accident dissemination system may further include a relay processor to obtain the accident information from the vehicle processor or the oncoming vehicle, and to open a second D channel, thereby retransmitting the accident information to the vehicle at the rear.

According to another aspect of the present invention, there is provided a method of disseminating an accident, the method including: sensing, at a sensor, the accident to thereby generate accident information; and opening, at a vehicle processor, an S channel to thereby transmit the accident information to a vehicle at the rear entering an accident location where the accident has occurred, and transmitting the accident information to an oncoming vehicle, travelling in the opposite direction and being alienated from the accident location, via a first D channel opened by the oncoming vehicle.

According to embodiments of the present invention, it is possible to enable an emergency disposal to be quickly performed by transferring accident information to a control center server via a vehicle, or to prevent a traffic congestion by transmitting accident information to a vehicle that is to enter an accident location where an accident has occurred.

According to embodiments of the present invention, it is possible to reduce a cost for a network facility expansion by disseminating accident information via a radio frequency channel between vehicle processors included in travelling vehicles.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of an accident dissemination system according to an embodiment of the present invention; and

FIG. 2 is a flowchart illustrating a method of disseminating an accident according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures. Hereinafter, an accident dissemination system and method according to embodiments of the present invention will be described with reference to the accompanying drawings.

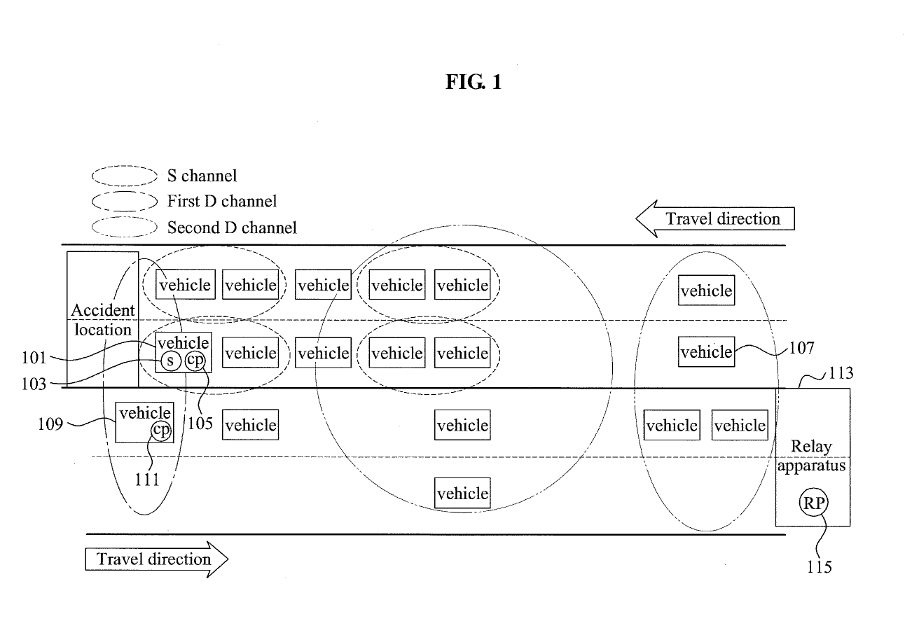

FIG. 1 is a diagram illustrating a configuration of an accident dissemination system according to an embodiment of the present invention. Even though not illustrated in FIG. 1, each vehicle may include at least one of a sensor and a vehicle processor. Referring to FIG. 1, the accident dissemination system may include a sensor 103, a vehicle processor 105, and a relay processor 115.

The sensor 103 may be attached to a facility positioned in an accident location where an accident has occurred, or a vehicle 101. The sensor 103 may sense the accident and generate accident information. For example, when a speed of an accident vehicle is less than or equal to a predetermined reference speed, the sensor 103 may sense the accident and generate accident information. The sensor 103 may generate, as the accident information, at least one of the accident location where the accident has occurred, an accident time when the accident occurred, and an accident cause.

The vehicle processor 105 may be included in the facility positioned at the accident location or the vehicle 101. The vehicle processor 105 may open an S channel and transmit the accident information to a vehicle at the rear 107 entering the accident location, and may transmit the accident information to an oncoming vehicle 109, travelling in the opposite direction and being alienated from the accident location, via a first D channel opened by the oncoming vehicle 109. When a vehicle processor 111 within the oncoming vehicle 109 receives accident information may retransmit the accident information to the vehicle at the rear 107 or the relay processor 115.

By transmitting the accident information to the vehicle at the rear 107, the vehicle processor 105 may limit entering of vehicles with respect to the accident location, thereby preventing a traffic congestion. Also, the vehicle processor 105 may transmit the accident information to the oncoming vehicle 109 and thereby prepare an environment where the accident information is disseminated through retransmission of the oncoming vehicle 109.

The relay processor 115 may be included in a relay apparatus 113 positioned at a location spaced apart from the accident location by a predetermined distance. The relay processor 115 may obtain the accident information from the vehicle processor 105 or the oncoming vehicle 109, and may open a second D channel and thereby retransmit the accident information to the vehicle at the rear 107.

Here, the relay processor 115 may receive the accident information via the S channel when the accident location is within a predetermined range, or may receive the accident information via the first D channel opened by the vehicle processor 111 within the oncoming vehicle 109 when the accident location is outside the predetermined range. For example, when the accident location is positioned within a relatively short distance, the relay processor 115 may receive the accident information via the S channel. When the accident location is positioned within a relatively long distance, the relay processor 115 may receive the accident information via the first D channel opened by the vehicle processor 111 of the oncoming vehicle 109.

The relay processor 115 may transfer the accident information to a control center server to thereby enable an emergency disposal unit to be dispatched to the accident location. Accordingly, an emergency disposal may be quickly performed.

Each of the S channel, the first D channel, and the second D channel may correspond to a radio frequency channel. Here, the S channel may correspond to a communication channel between vehicles travelling in the same direction, the first D channel may correspond to a communication channel between vehicles travelling in different directions, and the second D channel may correspond to a communication channel with the communication apparatus 113.

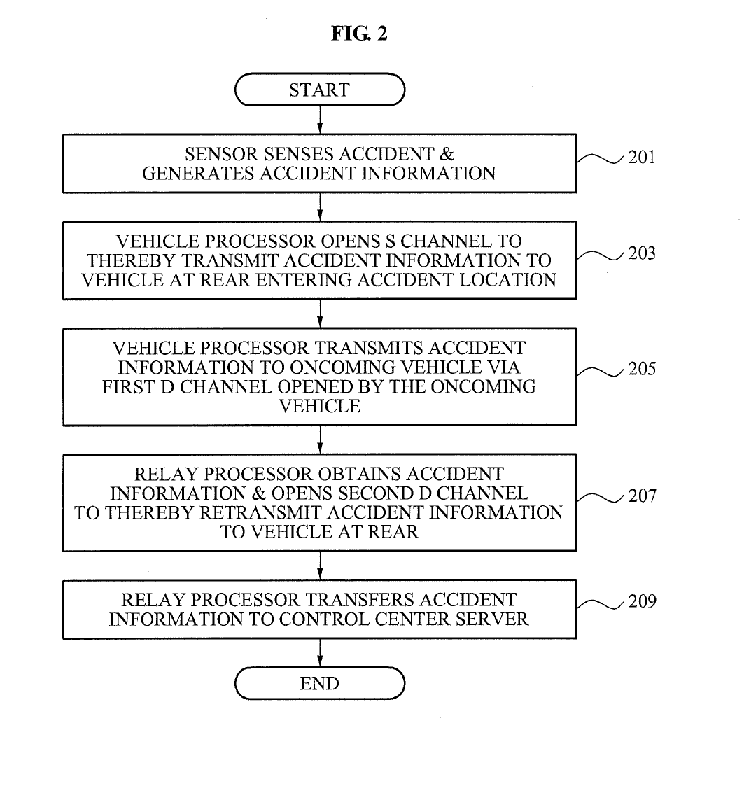

FIG. 2 is a flowchart illustrating a method of disseminating an accident according to an embodiment of the present invention.

Referring to FIG. 1, in operation 201, a sensor may sense the accident and generate accident information. For example, when a speed of an accident vehicle is less than or equal to a predetermined reference speed, the sensor may sense the accident and generate accident information.

In operation 203, a vehicle processor may open an S channel and transmit the accident information to a vehicle at the rear entering the accident location.

By transmitting the accident information to the vehicle at the rear, the vehicle processor may limit entering of vehicles with respect to the accident location, thereby preventing a traffic congestion.

In operation 205, the vehicle processor may transmit the accident information to an oncoming vehicle, travelling in the opposite direction and being alienated from the accident location, via a first D channel opened by the oncoming vehicle.

When the oncoming vehicle receives the accident information, the oncoming vehicle may retransmit the accident information to the vehicle at the rear or the relay processor.

In operation 207, the relay processor may obtain the accident information from the vehicle processor or the oncoming vehicle, and may open a second D channel to thereby retransmit the accident information to the vehicle at the rear.

Here, the relay processor may receive the accident information via the S channel when the accident location is within a predetermined range, or may receive the accident information via the first D channel opened by a vehicle processor within the oncoming vehicle when the accident location is outside the predetermined range.

In operation 209, the relay processor may transfer the accident information to a control center server to thereby enable an emergency disposal unit to be dispatched to the accident location.

According to embodiments of the present invention, it is possible to enable an emergency disposal to be quickly performed by transferring accident information to a control center server via a vehicle, or to prevent a traffic congestion by transmitting accident information to a vehicle that is to enter an accident location where an accident has occurred.

According to embodiments of the present invention, it is possible to reduce a cost for a network facility expansion by disseminating accident information via a radio frequency channel between vehicle processors included in travelling vehicles.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system for disseminating an accident, the system comprising:
a sensor to sense the accident and to generate accident information; and
a vehicle processor to open an S channel and thereby transmit the accident information to a vehicle at the rear entering an accident location where the accident has occurred, and to transmit the accident information to an oncoming vehicle, travelling in the opposite direction and being alienated from the accident location, via a first D channel opened by the oncoming vehicle.

2. The system of claim 1, further comprising:
a relay processor to obtain the accident information from the vehicle processor or the oncoming vehicle, and to open a second D channel, thereby retransmitting the accident information to the vehicle at the rear.

3. The system of claim 2, wherein the relay processor receives the accident information via the S channel when the accident location is within a predetermined range, or receives the accident information via the first D channel opened by a vehicle processor within the oncoming vehicle when the accident location is outside the predetermined range.

4. The system of claim 2, wherein the relay processor transfers the accident information to a control center server to thereby enable an emergency disposal unit to be dispatched to the accident location.

5. The system of claim 2, wherein when the accident information is received, a vehicle processor within the oncoming vehicle retransmits the accident information to the vehicle at the rear or the relay processor.

6. The system of claim 2, wherein each of the S channel, the first D channel, and the second D channel corresponds to a radio frequency channel.

7. The system of claim 1, wherein the sensor is attached to a facility or a vehicle positioned at the accident location to sense the accident.

8. The system of claim 1, wherein when a speed of an accident vehicle is less than or equal to a predetermined reference speed, the sensor senses the accident.

9. A method of disseminating an accident, the method comprising:
sensing, at a sensor, the accident to generate accident information; and
opening, at a vehicle processor, an S channel to thereby transmit the accident information to a vehicle at the rear entering an accident location where the accident has occurred, and transmitting the accident information to an oncoming vehicle, travelling in the opposite direction and being alienated from the accident location, via a first D channel opened by the oncoming vehicle.

10. The method of claim 9, further comprising:
obtaining, at a relay processor, the accident information from the vehicle processor or the oncoming vehicle; and
opening, at the relay processor, a second D channel to thereby retransmit the accident information to the vehicle at the rear.

11. The method of claim 10, wherein the obtaining comprises receiving the accident information via the S channel when the accident location is within a predetermined range, or receiving the accident information via the first D channel opened by a vehicle processor within the oncoming vehicle when the accident location is outside the predetermined range.

12. The method of claim 10, further comprising:
transferring, at the relay processor, the accident information to a control center server to thereby enable an emergency disposal unit to be dispatched to the accident location.

13. The method of claim 10, further comprising:
retransmitting, at a vehicle processor within the oncoming vehicle, the accident information to the vehicle at the rear or the relay processor when the accident information is received.

14. The method of claim 9, wherein the sensing and the generating comprises sensing the accident when a speed of an accident vehicle is less than or equal to a predetermined reference speed.
